(19) United States
(12) Patent Application Publication
(10) Pub. No.: US 2008/0224681 A1
(43) Pub. Date: Sep. 18, 2008

(54) Controller for a DC to DC Converter

(75) Inventors: Marius Padure, Bucharest (RO); Serban-Mihai Popescu, Campbell, CA (US); Laszlo Lipcsei, Campbell, CA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: O2MICRO, INC., Santa Clara, CA (US)

(21) Appl. No.: 12/053,943

(22) Filed: Mar. 24, 2008

Related U.S. Application Data
(63) Continuation-in-part of application No. 11/468,146, filed on Aug. 29, 2006.
Application No. 11/468,146 is a continuation of application No. 11/037,598, filed on Jan. 18, 2005, now Pat. No. 7,098,642.
Application No. 11/037,598 is a continuation of application No. 10/668,459, filed on Sep. 23, 2003, now Pat. No. 6,844,710.
Application No. 10/668,459 is a continuation-in-part of application No. 10/389,037, filed on Mar. 14, 2003, now Pat. No. 6,965,221.
(60) Provisional application No. 60/425,553, filed on Nov. 12, 2002.

(51) Int. Cl. G05F 1/44

(52) U.S. Cl. 323/288

(57) ABSTRACT

A controller for a DC to DC converter. The controller may include a resistor coupled to a switching node of the DC to DC converter. The switching node may be coupled to a high side switch and a low side switch of the DC to DC converter. A current level through the resistor may be responsive to a state of the high side switch and said low side switch. The controller may further include ramp generation circuitry responsive to the current level through the resistor to provide a ramp signal, and pulse width modulation (PWM) circuitry configured to generate a PWM signal in response to at least the ramp signal.

### CROSS REFERENCE TO RELATED APPLICATIONS

The present application is a continuation-in-part of U.S. patent application Ser. No. 11/468,146, filed Aug. 29, 2006, which itself is a continuation of U.S. patent application Ser. No. 11/037,598, filed Jan. 18, 2005 (now U.S. Pat. No. 7,098,642 issued on Aug. 29, 2006), which itself is a continuation of U.S. patent application Ser. No. 10/668,459, filed Sep. 23, 2003 (now U.S. Pat. No. 6,844,710, issued Jan. 18, 2005), which itself is continuation-in-part of U.S. patent application Ser. No. 10/389,037, filed Mar. 14, 2003 (now U.S. Pat. No. 6,965,221 issued on Nov. 15, 2005), all of which claim the benefit of U.S. Provisional Application Ser. No. 60/425,553, filed Nov. 12, 2002 and all of which are fully incorporated herein by reference.

### TECHNICAL FIELD

This disclosure relates to Direct Current (DC) to DC converters and, more particularly, to generating control signals for such converters.

### BACKGROUND

DC to DC converters typically convert an input DC voltage to an output DC voltage. Such conversions may include stepping down (buck) or stepping up (boost) the input DC voltage. To step down an input voltage, a DC to DC converter (e.g., a buck converter) may include a controllable switch (or switches) that cycles between an open position and a closed position. When closed, a stepped down output voltage is provided to a load. Additionally, when the switch is closed, energy may be stored in a component such as an inductor included in the converter. When the switch is opened, output voltage is provided to the load from the energy stored in the inductor. Since the switch (or switches) dissipates relatively small amounts of power, this power conservation may extend the life of the input voltage source (e.g., a battery) of the DC to DC converter.

### SUMMARY OF THE DISCLOSURE

According to one aspect of the disclosure, there is provided a controller for a DC to DC converter. The controller may include a resistor coupled to a switching node of the DC to DC converter. The switching node may be coupled to a high side switch and a low side switch of the DC to DC converter. A current level through the resistor may be responsive to a state of the high side switch and the low side switch. The controller may further include ramp generation circuitry responsive to the current level through the resistor to provide a ramp signal, and pulse width modulation (PWM) circuitry configured to generate a PWM signal in response to at least the ramp signal.

According to another aspect of the disclosure, there is provided a DC to DC converter. The DC to DC converter may include a pair of switches including a high side switch and a low side switch. The high side switch may be coupled to an input voltage of the DC to DC converter and a switching node. The low side switch may be coupled to ground and the switching node. The DC to DC converter may further include an inductor coupled to the switching node, and a controller configured to provide a PWM signal. The controller may include a resistor coupled to the switching node, wherein a current level through the resistor is responsive to a state of the high side switch and the low side switch. The controller may further include ramp generation circuitry responsive to the current level through the resistor to provide a ramp signal, and pulse width modulation circuitry configured to generate the PWM signal in response to the ramp signal.

According to yet another aspect of the disclosure there is provided a method. The method may include generating a ramp signal in response to a current level through a resistor. The resistor may be coupled to a switching node of a DC to DC converter. The switching node may be coupled to a high side switch and a low side switch of the DC to DC converter. The method may also include generating a PWM signal in response to the ramp signal.

Additional advantages and aspects of the present disclosure will become readily apparent to those skilled in the art from the following detailed description, wherein embodiments of the present invention are shown and described, simply by way of illustration of the best mode contemplated for practicing the present invention. As will be described, the present disclosure is capable of other and different embodiments, and its several details are susceptible of modification in various obvious respects, all without departing from the spirit of the present disclosure. Accordingly, the drawings and description are to be regarded as illustrative in nature, and not as limitative.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a block diagram of a DC to DC converter that includes a feedback path for providing switch state to a controller;

FIG. 2 is a table illustrating the states of the switches shown in FIG. 1 in response to two control signals;

FIG. 3 is a block diagram of an exemplary embodiment of the controller shown in FIG. 1;

FIGS. 4A and 4B are timing diagrams of signals associated with the controller shown in FIG. 3;

FIG. 5 is a block diagram of another exemplary embodiment of the controller shown in FIG. 1;

FIGS. 6A and 6B are timing diagrams of signals associated with the controller shown in FIG. 5;

FIG. 7 is a block diagram of yet another exemplary embodiment of a controller in accordance with the present disclosure;

FIG. 8 is a timing diagram of signals associated with the controller shown in FIG. 7; and

FIG. 9 is a flow chart of some operations of the controller shown in FIG. 1.

### DETAILED DESCRIPTION

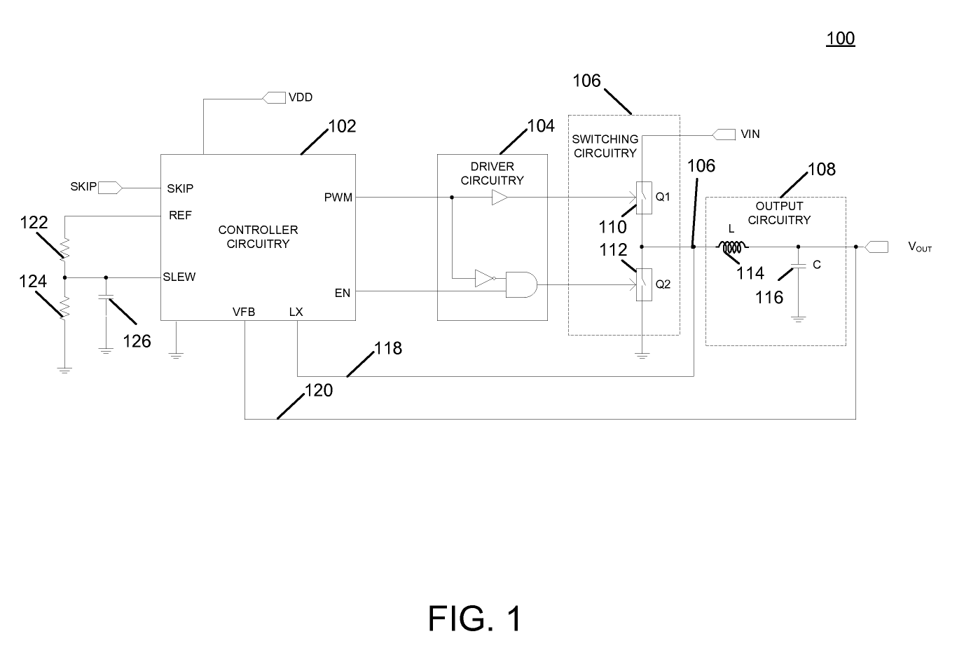

Referring to FIG. 1, an exemplary DC to DC converter 100 is shown that may include controller circuitry 102, driver circuitry 104, switching circuitry 106 and energy storage circuitry 108. In general, controller circuitry 102 may generate one or more control signals that may be provided to driver circuitry 104. For example, controller circuitry 102 may produce a pulse width modulation (PWM) signal to control switching circuitry 106. A pair of switches may be included in switching circuitry 106. In particular, a high side switch 110 and a low side switch 112 may respectively receive control signals from driver circuitry 104 and provide a signal to energy storage circuitry 108 for producing an output voltage (labeled V_{OUT}). In general, driver circuitry 104 may control switches 110 and 112 such that each switch 110, 112 may be alternatively placed in an “ON” and “OFF” position. In particular, one or more PWM signals provided by controller circuitry 102 may control the state of the high and low side switches 110, 112 by varying the duty cycle of the PWM signal. In this embodiment, if the PWM signal is high, high side switch 110 may be placed in an “ON” position and low side switch 112 may be placed in an “OFF” position. This situation is referred to as a “switch ON” state. In such a situation, an inductor 114 included in output circuitry 108 may be connected to an input voltage (labeled V_{IN}) by way of high side switch 110. Accordingly, the current flowing through inductor 114 may increase and charge may be stored in a capacitor 116 also included in output circuitry 108. The input voltage V_{IN} may be larger than output voltage (V_{OUT}) and a positive voltage may be present across inductor 114 when high side switch 118 in an “ON” position.

If the PWM signal is low, high side switch 110 may be in an “OFF” position and low side switch 112 may be in an “ON” position. This state of switches 110 and 112 may be referred to as a “switch OFF” state. In this situation, a negative voltage may be present across inductor 114. Accordingly, the magnetic field stored by inductor 114 may collapse and may provide V_{OUT} across capacitor 116. Thus, V_{OUT} may be provided based on the duty cycle of the PWM signal provided by controller circuitry 102. Controller circuitry 102 may also provide an Enable signal to driver circuitry 104. In this arrangement, the Enable signal is provided from a port labeled “EN” and may also control the state of high side switch 110 and low side switch 112.

In this embodiment, to produce the PWM signal and the Enable signal, two voltage feedback signals may be provided to controller circuitry 102. In particular, the output voltage (V_{OUT}) may be provided over a path 120 into a port labeled “VFB”. Additionally, the voltage present on one side of inductor 114 may be provided over another path 118 to control circuitry 102 via a port labeled “LX”. The feedback signal provided by path 118 may be used to determine the state of high side switch 110 and low side switch 112. Components may be used for setting parameters associated with controller circuitry 102. For example, a resistor 122 and a resistor 124 along with a capacitor 126 may be connected to controller circuitry 102 for setting parameters such as a reference voltage and current and/or voltage slew rate.

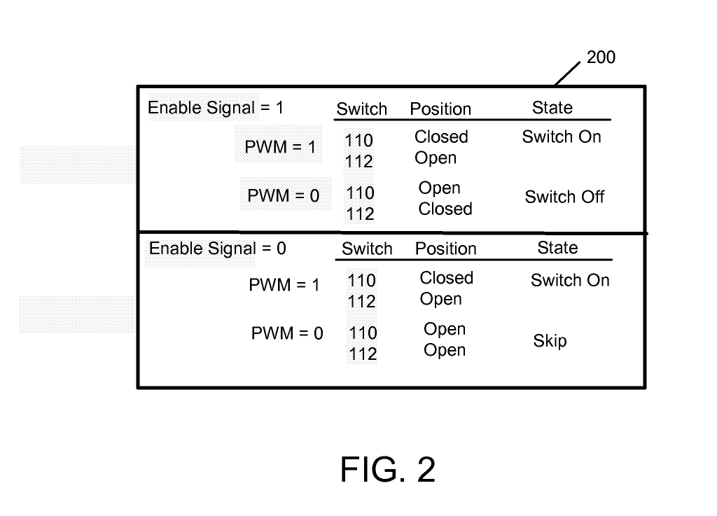

FIG. 2 includes an exemplary table 200 that illustrates the possible positions of switches 110 and 112 depending upon the logic level of the Enable signal EN and the PWM signal PWM provided by controller circuitry 102. Additionally, a state may be is defined by the position of switches 110 and 112. For example, if switch 110 is closed and switch 112 is open (e.g., Enable signal=1 and PWM signal=1), a “switch on” state is defined. In this state inductor 114 is connected the input voltage V_{IN}. If switch 110 is open and switch 112 is closed (e.g., Enable signal=1 and PWM signal=0), a “switch off” state is defined. In this state, inductor 114 is connected to the ground potential. A “skip” state is defined when both switches 110 and 112 are open and the Enable signal is a logic “0”. Since both switches 110, 112 are open during this skip state, inductor 114 is floating (i.e., not connected to the source voltage or ground). Thus inductor 114 may be connected to the input voltage (i.e., switch 110 is closed) in the “switch on” state, a ground potential (i.e., switch 112 is closed) in the “switch off” state, or be floating (i.e., both switch 110 and 112 are open) during the “skip” state.

In the “switch on” state, the voltage across inductor 114 may be substantially equivalent to V_{IN}−V_{OUT}. For buck conversions, the input voltage V_{IN} may be larger than the output voltage V_{OUT} and a net positive voltage may be across inductor 114. Due to this voltage, current flowing through inductor 114 ramps up according to:

di/dt=(V_{IN}−V_{OUT})/L=ΔI/T_{ON} (1)

In equation (1), V_{IN} may be the input voltage to DC to DC converter 100, V_{OUT} may be the output voltage of the DC to DC converter 100, T_{ON} may be the time interval duration that the switches 110 and 112 are in the “switch on” state, L may be the inductance of inductor 114, and ΔI may be the change in the current flowing through inductor 114 during T_{ON}.

During the “switch off” state, the voltage across the inductor 114 may be proportional to V_{OUT}. However, the polarity of the voltage across inductor 114 may reverse, and the inductor current ramps down according to:

di/dt=−(V_{OUT})/L=ΔI/T_{OFF}. (2)

In equation (2), V_{OUT} may be the output voltage of DC to DC converter 100, T_{OFF} may be the time interval duration that switches 110 and 112 are in the “switch off” state, L may be the inductance of inductor 114, and ΔI may be the change in the current flowing through inductor 114 during T_{OFF}.

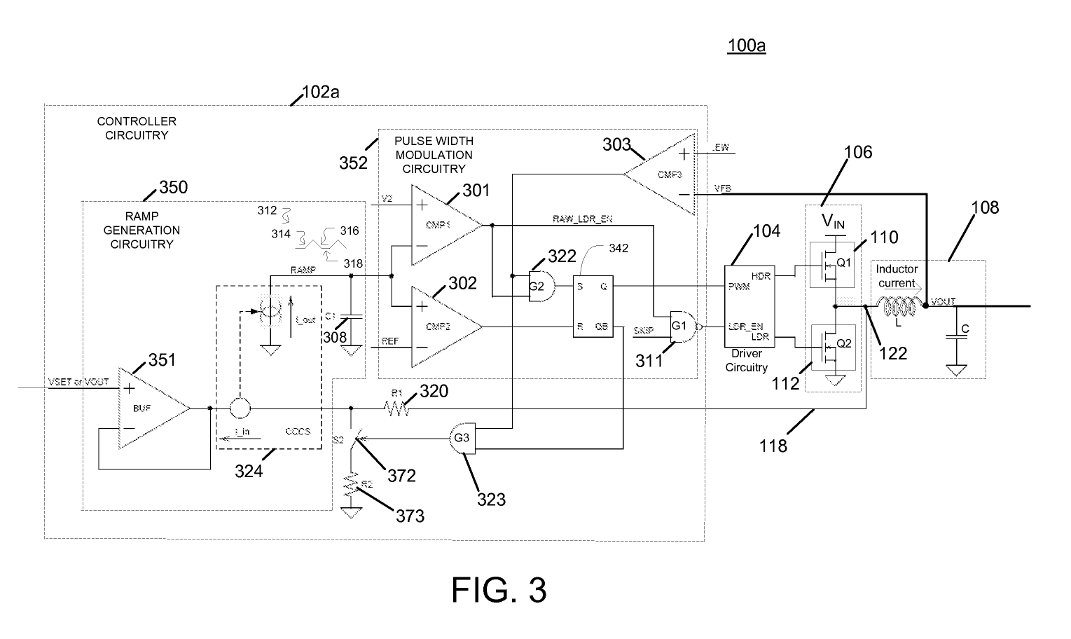

Turning to FIG. 3, a block diagram of one embodiment of converter 100a including a controller 102a consistent with the converter 100 of FIG. 1 is illustrated. The controller 102a may be utilized with a variety of DC to DC converters 100a. For example, the DC to DC converter 100a may comprise a synchronous buck converter generally including the controller 102a, a driver circuit 104, a pair of switches 106 including a high side switch 110 and a low side switch 112, and a low pass filter 108. The low pass filter 108 may include an inductor L and a capacitor C. The high side switch 110 may be coupled between an input DC voltage V_{IN} and a switching node LX 122. The low side switch 112 may be coupled between the switching node LX 122 and ground. The switching node LX 122 may further be coupled to the low pass filter 108.

The controller 102a may comprise pulse width modulations circuitry 352 configured to generate a pulse width modulation (PWM) signal and a low side switch enable signal (LDR_EN). In response to the PWM and LDR_EN signals, the driver circuit 104 may control the state of the high side and low side switches 110 and 112 to turn on and/or turn off.

The controller 102a may accept an input signal representative of the voltage at the switching node LX 122. The controller 102a may also have a target input terminal SLEW where the desired output voltage is set (e.g., VSET or VOUT). For example, in the exemplary embodiment of FIG. 1, the slew capacitor 126 may charge based on the value of the resistors 122, 124 in the resistor divider and the value of the reference voltage REF. Those skilled in the art will recognize various ways to charge the slew capacitor 126 and create the target voltage signal. In this instance, the voltage slews from 0 to a set value due to the slew capacitor 126. In addition, terminal VFB of the controller 102a may accept a feedback signal representative of the output voltage level VOUT of the DC to DC converter 100a.

The controller 102a as illustrated in FIG. 3 may include a resistor R1 320 that may be coupled to the switching node LX 122 of the DC to DC converter 100a. A current level through the resistor R1 320 may be responsive to a state of the high and low side switches, 110 and 112, e.g., whether the high and low side switches 110, 112 are in the switch ON state, the switch OFF state, or the skip state. The controller 102a may further include ramp generation circuitry 350 responsive to the current level through the resistor R1 320 to provide a ramp signal 312. The pulse width modulation circuitry 352 may be configured to generate a PWM signal in response to at least the ramp signal 312.

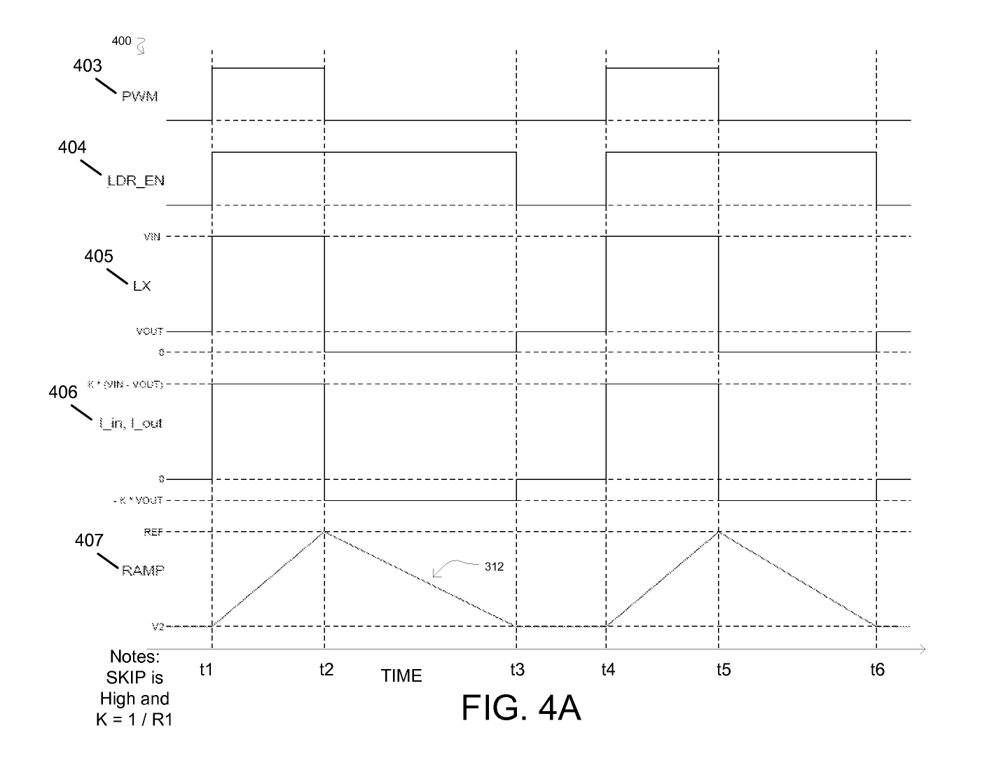

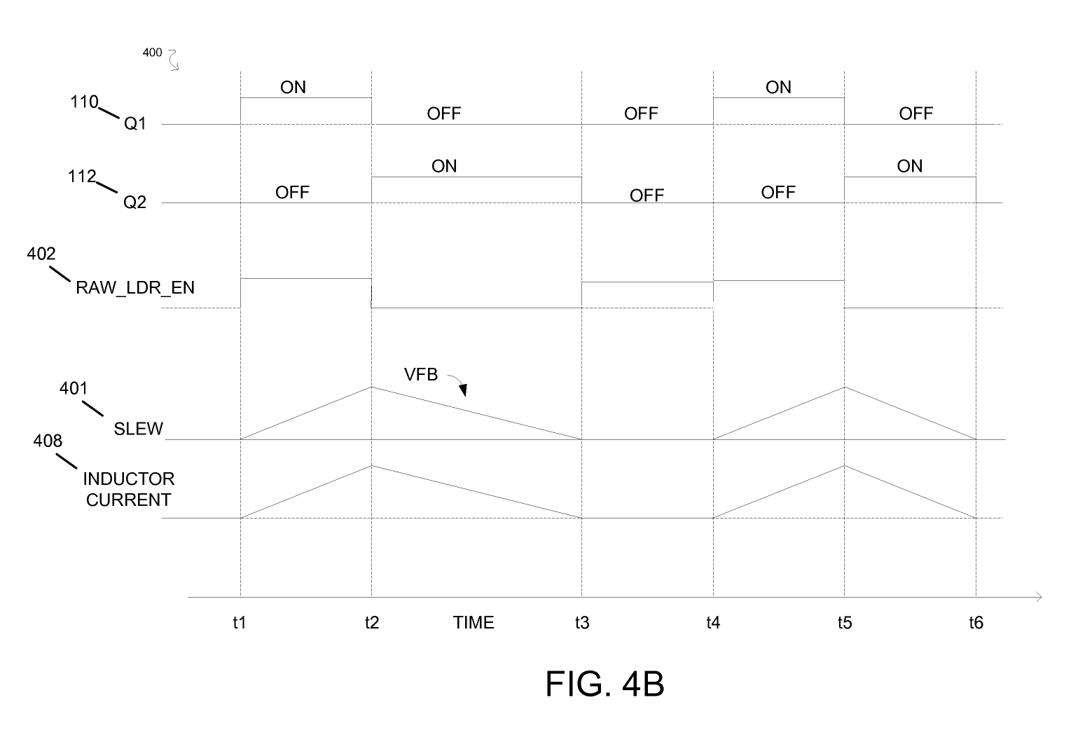

During the switch ON state when switch 110 is ON and switch 112 is OFF, the voltage level of the LX switching node 122 may be equal to VIN since switch 110 is ON and the LX switch node is coupled to VIN. Accordingly, the current passing through the resistor R1 320 may be equal to the input voltage VIN of the DC to DC converter 100a less the output voltage VOUT of the DC to DC converter 100a divided by a resistance value of the resistor R1 320. In response to this current level through the resistor R1 320, the ramp generation circuitry 350 may generate a portion 314 of the ramp signal 312 as will be discussed more in FIGS. 4a and 4b.

During the switch OFF state when switch 110 is OFF and switch 112 Q2 is ON, the voltage level of the LX switching node 122 may be equal to zero volts since the LX switching node 122 may be coupled to ground via the closed low side switch 112. Accordingly, the current passing through the resistor R1 320 may be equal to zero volts less the output voltage VOUT of the DC to DC converter 100a divided by a resistance value of the resistor R1 320. In response to this current level through the resistor R1 320, the ramp generation circuitry 350 may generate another portion 316 of the ramp signal 312 as will be discussed more in FIGS. 4a and 4b.

During the skip state (e.g., when switch 110 is OFF and switch 112 is OFF), the voltage level of the LX switching node 122 may be equal to the output voltage VOUT of the DC to DC converter 100a. Accordingly, the current passing through the resistor R1 320 may be equal to zero in the skip state since the voltage at the LX switching node 122 (for example, VOUT) less the output voltage VOUT divided by a resistance value of the resistor R1 320 may be zero. In response to this current level through the resistor R1 320, the ramp generation circuitry 350 may generate another portion 318 of the ramp signal 312 as will be discussed more in FIGS. 4a and 4b.

The ramp generation circuitry 350 may include a buffer 351 and a current controlled current source 324. The buffer 351 may have its inverting input coupled to the output of the buffer 351 to provide negative feedback. The voltage received at the noninverting input of the buffer 351 may be a voltage representative of the output voltage of the DC to DC converter 100a such as VSET or VOUT. The output voltage of the buffer 351 may therefore closely follow the input voltage VSET or VOUT input to the noninverting input. The current controlled current source 324 may be responsive to the input current I_in through the resistor R1 320 as that current level varies depending on the state of switches 110 and 112. The current controlled current source 324 may provide an output current I_out that mirrors the input current I_in. The output current I_out may enable charging and discharging of the ramp capacitor 308 in order to provide the ramp signal 312 to the first and second comparators 301 and 302 of the pulse width modulation circuitry 352.

The first comparator 301 may compare the ramp signal 312 with a nominal voltage value V2. In one embodiment, the nominal voltage value V2 may be 20 millivolts. The first comparator 301 may provide an output signal RAW_LDR_EN that may be received by the NAND gate 311. The NAND gate 311 may also receive a SKIP signal and provide an output LDR_EN signal to the driver circuitry 104. The second comparator 302 may compare the ramp signal 312 with a reference voltage REF and provide an output signal to the reset terminal R of the flip flop 342. The “Q” output of the flip flop 342 may provide a PWM signal to the driver 104.

The duty cycle of the PWM signal may be inversely proportional to the difference between the input voltage and the output voltage or the target voltage. In other words, as this difference increases, the duty cycle of the PWM signal may decrease thereby decreasing the “switch ON” time of the switches 110 and 112. Conversely, as the difference between the first signal and second signal decreases, the duty cycle of the PWM signal may increase thereby decreasing the “switch OFF” time of the switches 110 and 112.

Turning to FIGS. 4A and 4B in conjunction with FIG. 3, a timing diagram 400 to further illustrate operation of the controller 102a of FIG. 3 including generation of the ramp signal 312 is illustrated. When the controller 102a is enabled, the SLEW voltage 401 (FIG. 4b) may start to increase. The comparator 302 of FIG. 3 may then sense that the SLEW voltage reaches the feedback voltage VFB and may provide a digital one signal to the AND gate 322. The output of the first comparator 301 (e.g., the RAW_LDR_ENB signal 402 in FIG. 4b) may also be a digital one at this time. Accordingly, all inputs to the AND gate 322 may be a digital one and the output of the AND gate 322 may then set the flip flop 342. At that moment or time t1, the PWM signal 403 (FIG. 4a) may go to a digital one.

During the time interval between times t1 and t2, the PWM signal 403 may be a digital one and the LDR_EN signal 404 may also be a digital one. Hence the high side switch 110 and low side switch 112 are in the switch ON state with switch 1100N and switch 112 OFF. Accordingly, the voltage 405 at the LX switching node 122 may be equal to VIN between times t1 and t2 since the LX switching node 122 may be tied to the input voltage VIN of the DC to DC converter 100a during this time interval.

The current level I_in through the resistor 320 during this t1 to t2 time interval may be provided by equation (3):

I_in=(VIN−VOUT)/R1; (3)

where VIN may be the input voltage of the DC to DC converter 100a, VOUT may be the output voltage of the DC to DC converter 100a, and R1 is the value of the resistor 320 of FIG. 3. If K=1/R1, then equation (3) may be rewritten as detailed in equation (4).

I_in=K*(VIN−VOUT) (4)

Since I_out mirrors I_in, I_out may also be equal to I_in as detailed in equations (3) and (4) and as illustrated by plot 406. During the time interval between times t1 and t2, the ramp signal 312 may ramp up in proportion to the I_out signal as shown by plot 407. The ramp signal 312 may ramp up until it reaches the reference voltage REF input to the inverting input terminal of the second comparator 302. When the ramp signal 312 reaches the REF level at time t2, the output of the second comparator 302 may reset the flip flop 342.

When the flip flop 342 is reset at time t2, the Q output of the flip flop 342 may become a digital zero and hence the PWM signal 403 may be a digital zero. The RAW_LDR_ENB signal 402 output the first comparator 301 may be a digital zero and the SKIP signal may be a digital one so the output of the NAND gate 311 (e.g., the LDR_EN signal 404) may also be a digital one. Accordingly, the switches 110 and 112 may be in a switch OFF state between time intervals t2 and t3 with the high side switch 110 OFF and the low side switch 1120N. When switches 110 and 112 are in this switch OFF state, the voltage at the LX switching node 122 may be equal to 0 as detailed by plot 405 since the LX switching node 122 may be coupled to ground via the closed low side switch 112.

The current level I_in 406 through the resistor 320 during the time interval between times t2 and t3 may be given by equation (5):

I_in=(0−VOUT)/R1 (5)

If K=1/R1, then equation (5) may be rewritten as detailed in equation (6):

I_in=−K*VOUT (6)

Since I_out mirrors I_in, I_out may also be equal to I_in as detailed in equations (5) and (6) and as illustrated by plot 406. During the time interval between times t2 and t3, the ramp signal 312 may ramp down in proportion to the I_out signal 406. The ramp signal 312 may ramp down until it reaches the voltage level V2 input to the noninverting input terminal of the first comparator 301. At time t3 when the ramp signal 312 reaches voltage level V2, the output of the first comparator 301 (e.g., RAW_LDR_ENB 402) may go to a digital one. When the ramp signal 312 reaches the V2 voltage level at time t3, the inductor current as represented by plot 408 in FIG. 4b may be at a zero crossing. As such, the controller 102a may provide a zero crossing estimator of the inductor current through the inductor L without directly measuring such current.

If the SKIP signal is also a digital one at time t3 (e.g., so that the SKIP state is enabled), the output of the NAND gate 311 may be a digital zero and the LDR_EN signal 404 may be a digital zero. Accordingly, between times t3 and t4 the controller 102a may be in the skip state. In response to the digital zero PWM signal 403 and the digital zero LDR_EN signal 404, both switches 110 and 112 may be off in the skip state.

Accordingly, the voltage 405 at the LX switching node 122 as illustrated may be equal to VOUT of the DC to DC converter during the skip state when switches 110 and 112 are OFF. In addition, the current passing through the resistor 320 and the I_out current 406 may be equal to zero in the skip state since the voltage at the LX switching node 122 less the output voltage VOUT divided by a resistance value of the resistor 320 is zero.

When the skip state is enabled, the controller 102a may keep the switches 110 and 112 in the skip state until the output voltage of the DC to DC converter 100a as represented by VFB falls below a set voltage level (e.g., SLEW 401). The VFB signal may vary depending on whether the capacitor C of the low pass filter 108 of the DC to DC converter 100a has an equivalent series resistance (ESR) or not.

If the capacitor C has no ESR (e.g., the capacitor C may be a ceramic capacitor with no ESR), the voltage VFB as illustrated by plot 401 may increase as long as current flows through the inductor 114. During the t1 to t2 time interval, plot 401 may increase at a first slope when switch 110 is ON and switch 112 is OFF. During the t2 to t3 time interval, when switch 110 is OFF and switch 112 is ON, plot 401 may decay until it reaches SLEW at time t3. During the t3 to t4 time interval, plot 401 may be at a zero crossing when switches 110 and 112 are both OFF. At time t4, the output of the third comparator 303 may go to a digital one. The digital one from the third comparator 303 and from the first comparator 301 may cause the output of the AND gate 322 to go to a digital one to set the flip flop 342 and hence cause the PWM signal 403 to go to a digital one. The process may then repeat itself as illustrated in the timing diagram 400 for times t4 to t6. The rate of decay of plot 401 during the t3 to t4 time interval may depend on the load current. For example, the rate of decay may be slower for a light load current than for a comparatively larger load current. Therefore, the controller 102a may maintain the skip state for a longer time for a light load current than for the comparatively larger load current.

If the capacitor C has an ESR, then the plot (not illustrated) of VFB would increase during the t1 to t2 time interval, but decrease during the t2 to t3 time interval. The voltage VFB would then further decay during the t3 to t4 time interval similarly to that of plot 401 where the rate of decay may depend on the load current. The VFB signal may decay until it reaches SLEW when a new cycle may be started.

Turning back to FIG. 3, a switch 372 may close to affect the slope of the ramp signal 312 during certain time intervals, e.g., during time the t2 to t3 time interval or the t5 to t6 time interval, to shorten the duration of the switch OFF state. The switch 372 may be controlled by the output of the AND gate 323 and the switch 372 may close when both inputs to the AND gate 323 are a digital one. This may occur when the VFB voltage is less than the SLEW voltage so that the output of the third comparator 303 is a digital one and the “QB” terminal output of the flip flop 342 is a digital one when the PWM signal is a digital zero. When switch 372 is closed, the duration of the switch OFF state may be shortened compared to its duration if switch 372 was open. This may occur since the negative slope of the ramp signal 312 during the switch OFF state, e.g., during the t2 to t3 time interval, may be further decreased compared to its slope if switch 372 was open. The rate of the accelerated switch OFF state may be selected by the choice of the resistor R2 373. The controller 102a may also not include the switch 372, resistor 373, and AND gate 323 if this accelerated switch OFF time feature is not desired.

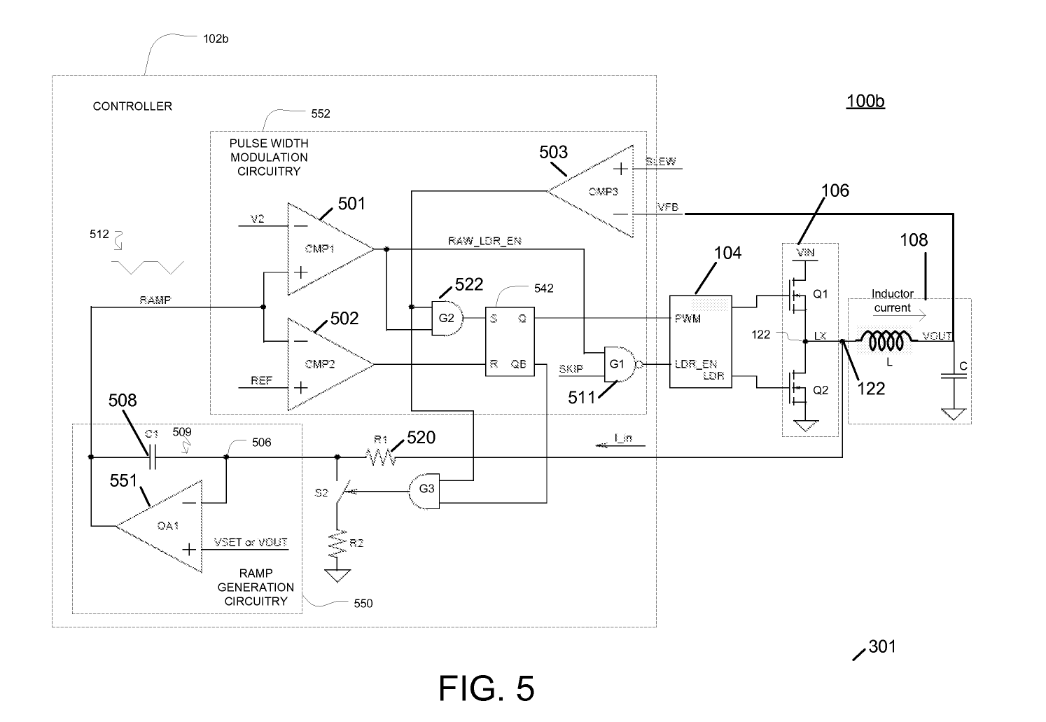

FIG. 5 shows another embodiment of a controller 102b consistent with FIG. 1. The description of parts in FIG. 5 that may be similar to FIG. 3 is omitted herein for clarity. The controller 102b may include a resistor R1 520 coupled to the switching node 122 of the DC to DC converter 100b. The controller 102b may include ramp generation circuitry 550 responsive to the current level through the resistor R1 520 to provide a ramp signal 512. The controller 102b may further include pulse width modulation circuitry 552 configured to generate a PWM signal in response to at least the ramp signal 512.

The ramp generation circuitry 550 may include a capacitor 508 coupled in series with the resistor R1 520 via the path 509. The operational amplifier 551 may have its inverting input coupled to node 506 and its noninverting input configured to receive a voltage representative of the output voltage of the DC to DC converter 100b, e.g., VSET or VOUT. The operational amplifier 551 may function as an integrator. If the noninverting input terminal accepts VOUT, the voltage at node 506 at one end of the resistor R1 520 may also be equal to VOUT. The current that flows through the resistor R1 520 may also flow into the ramp capacitor 508 to charge and discharge the ramp capacitor 508 as the operational amplifier 551 may prevent current flow into it.

The ramp signal 512 may be provided to the noninverting input terminal of the first comparator 501 and the inverting input terminal of the second comparator 502. The voltage level V2 may be provided to the inverting input terminal of the first comparator 501. The REF voltage may be provided to the noninverting input terminal of the second comparator 502. In one embodiment, VREF may be 0.01 volts and V2 may be 2.5 volts.

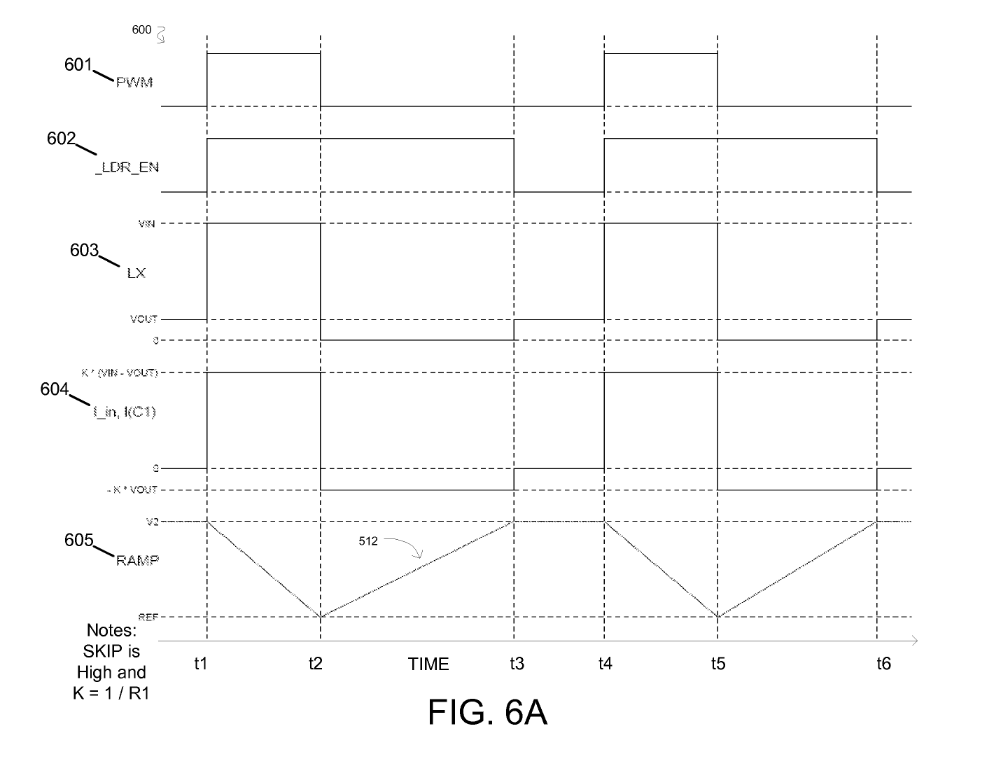

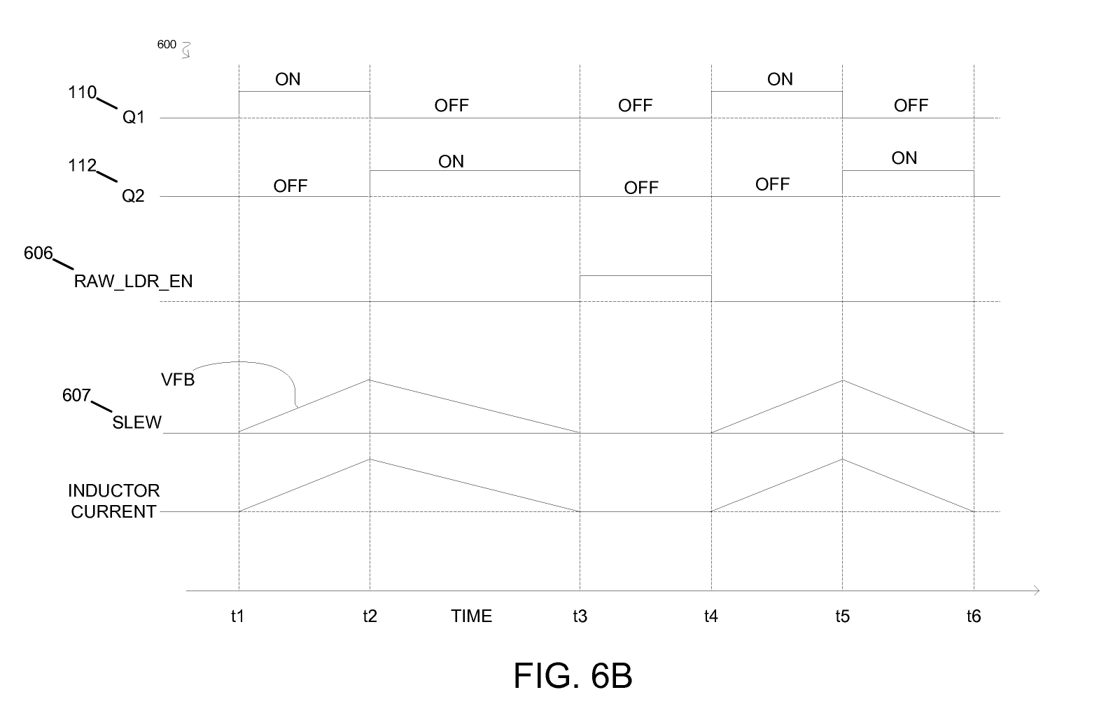

Turning to FIGS. 6A and 6B in conjunction with FIG. 5, a timing diagram 600 to further illustrate operation of the controller 102b of FIG. 5 including generation of the ramp signal 512 is illustrated. During the time interval between times t1 and t2, the PWM signal 601 is a digital one and the LDR_EN signal 602 is also a digital one. Hence the high side switch 110 is ON and the low side switch 112 is OFF. The voltage 603 at the LX switching node 122 may be equal to VIN between times t1 and t2 since the LX switching node 122 is tied to the input voltage VIN of the DC to DC converter during this time interval. The current level I_in 604 through the resistor 520 during the t1 to t2 time interval and also through the ramp capacitor 508 [I(C1)] may be given by equations (3) and (4). In response to this current level through the ramp capacitor 508, the plot 605 of ramp signal 512 may ramp down during the time interval between times t1 and t2. During times t1 and t2, the ramp signal 512 may have a negative slope because current level I_in 604 may pass through the ramp capacitor 508 by way of the operational amplifier 551. The ramp signal 512 may therefore be inverted in comparison to ramp signal 312 of FIG. 4A. Moreover, the polarity of the ramp capacitor 508 of the ramp signal 512 may be opposite of the ramp capacitor 308 of ramp signal 312 of FIG. 4A.

The ramp signal 512 may ramp down until it reaches the reference voltage REF input to the noninverting input terminal of the second comparator 502. When the ramp signal 512 reaches the REF level at time t2, the output of the second comparator 502 may reset the flip flop 542 of FIG. 5. When the flip flop 542 is reset at time t2, the Q output of the flip flop 542 may become a digital zero and hence the PWM signal 601 may be a digital zero. The RAW_LDR_EN signal 606 output of the first comparator 501 may be a digital zero and the SKIP signal may be a digital one during the t2 to t3 time interval so the output of the NAND gate 511 of FIG. 5 (e.g., the LDR_EN signal 602) may also be a digital one. Accordingly, the switches 110 and 112 may be in a switch OFF state during the t2 to t3 time interval with the high side switch 110 OFF and the low side switch 1120N. When switches 110 and 112 are in this switch OFF state, the voltage 603 at the LX switching node 122 may be equal to 0 since the LX switching node 122 may be coupled to ground via the closed low side switch 112.

The current level I_in 604 through the resistor 520 and through the ramp capacitor 508 [I(C1)] during the t2 to t3 time interval may be given by equations (5) and (6). In response, the ramp signal 512 may ramp up in proportion to the I_in and I(C1) current level until it reaches the V2 level at time t3. At time t3, the output of the first comparator 501 (e.g., RAW_LDR_EN 606) may go to a digital one. If the SKIP signal is also a digital one (e.g., so that the SKIP state is enabled), the output of the NAND gate 511 may be a digital zero and the LDR_EN signal 602 may switch to a digital zero at time t3. Accordingly, between times t3 and t4, the controller 102b may be in the skip state. In response to the digital zero PWM signal 601 and the digital zero LDR_EN signal 602, both switches 110 and 112 may be off in the skip state.

Accordingly, the voltage 603 at the LX switching node 122 may be equal to VOUT of the DC to DC converter 100b during the skip state when switches 110 and 112 are OFF. In addition, the current passing through the resistor 520 and ramp capacitor 508 may be equal to zero during the skip state. The controller 102b may keep the switches 110 and 112 in the skip state until the output voltage 607 of the DC to DC converter 100b as represented by VFB falls below a set voltage level (e.g., SLEW). When this occurs at time t4, the output of the third comparator 503 of FIG. 5 may go to a digital one. The digital one from the third comparator 503 and from the first comparator 501 may cause the output of the AND gate 522 of FIG. 5 to go to a digital one to set the flip flop 542 and hence cause the PWM signal 601 to go to a digital one. The process may then repeat itself as illustrated in the timing diagram 600 for times t4 to t6.

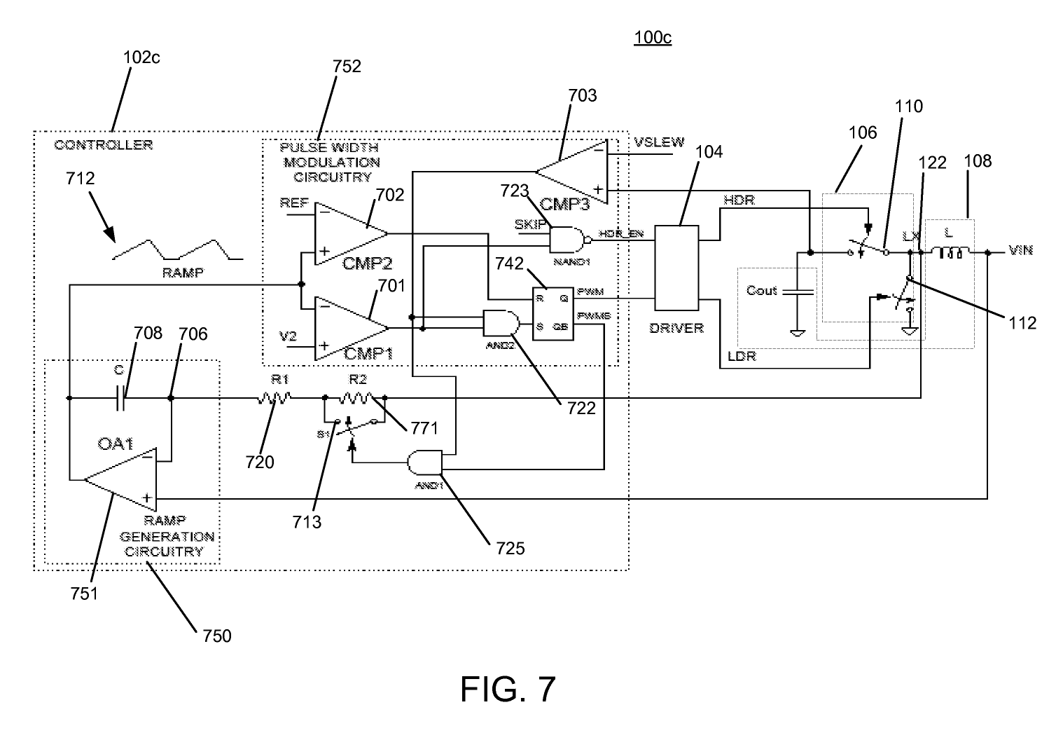

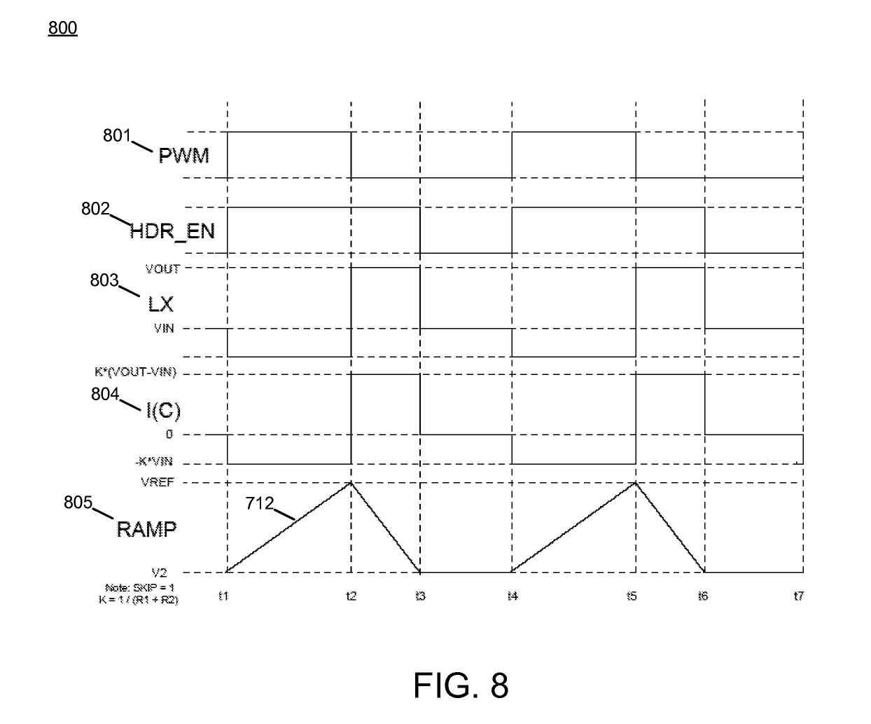

Referring now to FIG. 7 in conjunction with FIG. 8, yet another embodiment of the present disclosure including a converter 100c (for example, a boost converter) is shown. Converter 100c may include, inter alia, controller 102c, driver 104, and switches 110 and 112, which may be coupled to an inductor L. Controller 102c may be configured to generate a control signal to driver 104, which may then drive high and low side switches 110, 112. In some embodiments, driver 104 may adjust the duty cycle of converter 100c by turning each switch 110, 112 ON and/or Off thereby controlling the inductor current as well as the output voltage of the DC to DC converter 100c. Controller 102c may utilize a pulse width modulation (PWM) signal to control the state of the high and low side switches 110, 112 by varying the duty cycle of the PWM signal.

Generally, if the PWM signal is high, the low side switch 112 may be ON and the high side switch 110 may be OFF. This state of switches 110, 112 may be referred to herein as a “switch ON” state. In this state, inductor L may be coupled to ground. Accordingly, the inductor current may begin to ramp up. If the PWM signal 801 is low, the low side switch 112 may be OFF and the high side switch 110 may be ON. This state of switches 110, 112 may be referred to as a “switch OFF” state. In a boost converter 100c, there may be a net negative voltage across inductor L in this state. Accordingly, the inductor current may begin to ramp down during this low side switch OFF state. Thus, the duty cycle of the PWM signal may determine the time on for the switch ON state and the time off for the switch OFF state. Similar to the buck converter, controller 102c may utilize a ramp signal 712 to assist with generation of the PWM signal.

Controller 102c may include pulse width modulation circuitry 752 and ramp generation circuitry 750. PWM circuitry 752 may include comparators 701, 702, 703, AND circuitry 722, NAND circuitry 723 and SR latch 742. First comparator 701 may be configured to provide inputs to AND circuitry 722 as well as NAND circuitry 723. AND circuitry 722 may be configured to receive an additional input from third comparator 703. AND circuitry 722 may then generate an input to a flip-flop or latch such as SR latch 742. SR latch 742 may be configured to provide an input to driver 104 and AND circuitry 725, which may be located externally to PWM circuitry 752. PWM circuitry 752 may be configured to receive a signal 712 from ramp generation circuitry 750 and generate a PWM signal in response to the ramp signal 712. Ramp generation circuitry 750 may include operational amplifier 751 and capacitor 708 and may be responsive to the current level flowing through resistors R1 720 and R2 771 as discussed below.

Controller 102c may additionally include switch 713 and AND circuitry 725, which may have its inputs coupled to the output of third comparator 703 of PWM circuitry 752 and to the inverting output of SR latch 742. Controller 102c may further include resistors R1 720 and R2 771, which may be arranged in series and coupled to switching node LX 122 of DC to DC converter 100c.

As described herein, R1 720 in series with R2 771 may be denoted as an equivalent resistor R, thus having its resistance equal to R1+R2. In some embodiments, R1 720 may be R/6 and R2 771 may be 5*R/6. Ramp generation circuitry 750 may also include a capacitor C 708 coupled in series with resistor R. Operational amplifier 751 may have its inverting input coupled to a node 706 associated with resistor R and its non-inverting input configured to receive a voltage representative of the input voltage of the DC to DC converter 100c, for example VIN. Op amp 751 may function as an integrator. The current that flows through the resistor R may also flow into ramp capacitor C 708 to charge and discharge ramp capacitor C 708 as operational amplifier 751 may prevent current flow into it.

The ramp signal 712 may be provided to the inverting input terminal of first comparator 701 and the non-inverting input terminal of the second comparator 702. The voltage level V2 may be provided to the non-inverting input terminal of the first comparator 701. The REF voltage may be provided to the inverting input terminal of the second comparator 702. In some embodiments, VREF may be 2.5 volts and V2 may be 10 mV.

Controller 102c may generate a new ramp whenever the output voltage is greater than VSLEW voltage in OFF state. When in the OFF state, PWMB signal may be a logic one and the AND circuitry 725 may issue a logic one if the output voltage is greater than VSLEW voltage. Thus, switch S1 713 may be closed, reducing the R value. The ramp may be discharged rapidly down to the V2 level where the output of first comparator 701 may become a logic one, thus resetting the PWM latch. The PWMB signal may become a logic zero, therefore opening the switch S1713.

Referring now to FIG. 8, a timing diagram illustrating operation of controller 102c of FIG. 7 is shown. In some embodiments, the PWM signal 801 and the HDR_EN signal 802 may be a digital one between times t1 and t2. Thus, the low side switch 112 may be ON and the high side 110 switch may be OFF. The voltage at the LX switching node 803 may be equal to 0 between times t1 and t2. The current level I 804 through resistor R during the t1 to t2 time interval and also through the ramp capacitor C, I(C), may be found using the following equation:

I_in=−VIN/R

In response to this current level through the ramp capacitor C 708, the plot 805 of the ramp signal 712 may ramp up during the time interval between times t1 and t2. During times t1 and t2, the ramp signal 712 may have a positive slope because the current level I_in 804 may pass through ramp capacitor C 708 via operational amplifier 751.

Once flip flop 742 is reset at time t2, the Q output of flip flop 742 may become a digital zero and hence the PWM signal 801 may be a digital zero. When switches 110 and 112 are in this switch OFF state, the voltage 803 at the LX switching node 122 may be equal to VOUT as detailed by FIG. 8. This may be a result of LX switching node 122 being coupled to output voltage via the closed high side switch 110.

The current level I_in 804 through first resistor R1 720 during the time interval between times t2 and t3 may be given by the equation:

I_in=(VOUT−VIN)/R1

During the time interval between times t2 and t3, the ramp signal 712 may ramp down in proportion to the I_in signal. The ramp signal 712 may ramp down until it reaches the voltage level V2 input to the inverting input terminal of the first comparator 701. At time t3, when the ramp signal 712 reaches voltage level V2, the output of first comparator 701 may go to a digital one. As shown in FIGS. 6A and 6B, when the ramp signal 512 reaches the V2 voltage level at time t3, the inductor current as represented by the plot 604 may be at a zero crossing. As such, controller 102c may provide a zero crossing estimator of the inductor current through the inductor L without directly measuring such current.

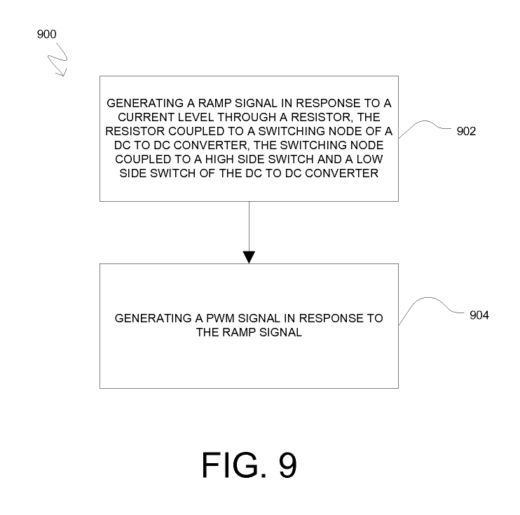

FIG. 9 illustrates operations 900 according to an embodiment. Operation 902 may include generating a ramp signal in response to a current level through a resistor, the resistor coupled to a switching node of a DC to DC converter, the switching node coupled to a high side switch and a low side switch of the DC to DC converter. Operation 904 may include generating a PWM signal in response to the ramp signal.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible.

What is claimed is:

1. A DC to DC converter comprising:
a pair of switches configured to control an output voltage of the DC to DC converter; and
a controller comprising:
pulse width modulation (PWM) circuitry configured to produce a first signal for controlling the operation of the pair of switches;
ramp generation circuitry configured to produce a second signal for producing the first signal; and
a resistive element configured to provide a current signal for producing the second signal.

2. The DC to DC converter of claim 1, wherein the resistive element includes a resistor.

3. The DC to DC converter of claim 1, wherein at least one of the switches is a metal oxide semiconductor field effect transistor (MOSFET).

4. The DC to DC converter of claim 1, wherein the current signal controls a level increase of the second signal.

5. The DC to DC converter of claim 1, wherein the current signal controls a level decrease of the second signal.

6. The DC to DC converter of claim 1, wherein said ramp generation circuitry includes a capacitor coupled to the resistive element.

7. The DC to DC converter of claim 6, wherein the capacitor is also coupled to ground and the level of the second signal increases in response to the current signal charging the capacitor.

8. The DC to DC converter of claim 6, wherein the capacitor is also coupled to an operational amplifier and the second signal decreases in response to the current signal charging the capacitor.

9. The DC to DC converter of claim 1, wherein said pair of switches comprises a high side switch and a low side switch, wherein the current signal is defined as:
(V_{IN}−V_{OUT})/R
if said high side switch is closed, wherein V_{IN} represents an input voltage of the DC to DC converter, V_{OUT} represents an output voltage of the DC to DC converter, and R represents the resistance of the resistive element.

10. The DC to DC converter of claim 1, wherein said pair of switches comprises a high side switch and a low side switch, wherein the current signal is defined as:
(0−V_{OUT})/R
if said low side switch is closed, wherein V_{OUT} represents an output voltage of the DC to DC converter and R represents the resistance of the resistive element.

11. The DC to DC converter of claim 1, wherein the current signal is substantially equivalent to zero if both of said pair of switches are open.

12. A DC to DC converter comprising:
a high side switch and a low side switch, wherein the high side switch is coupled to an input voltage and the low side switch is coupled to ground;
an inductor coupled to the high side switch and the low side switch, wherein the inductor is configured to provide an output voltage of the DC to DC converter; and
a controller, comprising:
pulse width modulation (PWM) circuitry configured to produce a first signal for controlling the high side switch and the low side switch;
ramp generation circuitry configured to provide a second signal to the pulse width modulation circuitry; and
a resistor configured to provide a current signal to the ramp generation circuitry indicative of the state of the high side switch and the low side switch.

13. The DC to DC converter of claim 12, wherein said ramp generation circuitry includes a capacitor configured to provide the second signal to the pulse width modulation circuitry, wherein the capacitor is further configured to be charged based, at least in part, on the current signal.

14. The DC to DC converter of claim 13, wherein said capacitor is coupled to ground and the level of the level of the second signal increases in response to the current signal charging the capacitor.

15. The DC to DC converter of claim 12, wherein the current signal is defined as:
(V_{IN}—V_{OUT})/R
if the high side switch is closed and the low side switch is open, wherein V_{IN} represents an input voltage of the DC to DC converter, V_{OUT} represents an output voltage of the DC to DC converter, and R represents the resistance of the resistor.

16. The DC to DC converter of claim 12, wherein the current signal is defined as:
(0−V_{OUT})/R
if the high side switch is open and the low side switch is closed, wherein V_{OUT} represents an output voltage of the DC to DC converter and R represents the resistance of the resistor.

17. The DC to DC converter of claim 12, wherein the current signal is substantially equivalent to zero if the high side switch is open and the low side switch is open.

18. A method comprising:
ramp generation circuitry, generating a first signal in response to a current signal from a resistor, wherein the current signal represents the state of a pair of switches; and
pulse width modulation circuitry, generating a second signal in response to the first signal, wherein the second signal controls the pair of switches.

19. The method of claim 18, wherein said pair of switches comprises a high side switch and a high side switch, wherein the current signal is substantially equivalent to:
(V_{IN}−V_{OUT})/R,
if said high side switch is closed, wherein V_{IN} represents an input voltage, V_{OUT} represents an output voltage, and R represents the resistance of the resistor.

20. The method of claim 18, wherein said pair of switches comprises a high side switch and a low side switch, wherein current signal is substantially equivalent to:
(0−V_{OUT})/R,
if said low side switch is closed, wherein V_{OUT} represents an output voltage and R represents the resistance of the resistor.

21. The method of claim 18, wherein the current signal is substantially equivalent to zero if both of said pair of switches is open.
